(19) United States
(12) Patent Application Publication
(10) Pub. No.: US 2007/0140704 A1
(43) Pub. Date: Jun. 21, 2007

(54) Optical transmitter with enhanced SBS threshold power capability

(76) Inventors: John Christopher Mauro, Painted Post, NY (US); Srikanth Raghavan, Ithaca, NY (US)

Correspondence Address: CORNING INCORPORATED, SP-TI-3-1, CORNING, NY, 14831, US

(21) Appl. No.: 11/314,106

(22) Filed: Dec. 20, 2005

(51) Int. Cl. H04B 10/04

(52) U.S. Cl. 398/188

(57) ABSTRACT

An optical transmitter (8) having enhanced stimulated Brillouin scattering (SBS) threshold power (PSBS) capability is disclosed. The transmitter includes a light source (12) adapted to emit a continuous-wave (CW) light beam (16). A phase modulator (20) is optically coupled to the light source and to a plurality n of radio-frequency (RF) signal drivers (22) adapted to generate a corresponding plurality of sinusoidal RF drive signals having respective modulation amplitudes Aₙ, modulation frequencies fₙ, and modulation phases φₙ. The phase modulator phase modulates the light beam based on the plurality of sinusoidal RF drive signals to form a phase-modulated carrier light beam (16′). The modulation phases φₙ are chosen to increase the SBS threshold power relative to a baseline threshold power when the phase-modulated carrier light beam travels over an optical fiber (50). Modulation frequencies fₙ are also chosen to suppress combined second-order (CSO) distortion.

### BACKGROUND OF THE INVENTION

1. Field of the Invention

The present invention relates generally to analog optical communication systems, and particularly to an analog optical transmitter for such systems that enhances the stimulated Brillouin scattering (SBS) threshold in an optical fiber while also controlling composite second order (CSO) distortions during data transmission.

2. Technical Background

Analog optical communication systems are finding use for applications previously associated with standard wire-based communication systems, such as telephony and cable television (CATV). This turn towards analog optical communications systems is driven in part by the increasing availability of broadband optical fiber networks in businesses and homes.

An optical analog communication system transmits an analog information signal over an optical fiber by modulating a carrier light beam with an information signal and transmitting the modulated carrier over the optical fiber to a receiver. For long-distance applications, high optical power levels are needed to avoid using additional network components such as amplifiers and repeaters, which add to the network cost. Unfortunately, the use of a high-powered, narrow-linewidth optical source in combination with a low-loss single-mode optical fiber can lead to non-linear effects that cause signal degradation. These nonlinear effects include stimulated Brillouin scattering (SBS), stimulated Raman scattering (SRS), self-phase modulation and, if two or more optical channels are involved, cross-phase modulation and four-wave mixing.

Of these non-linear effects, SBS is of particular importance because it sets an upper limit on the amount of optical power one can input into the optical fiber. A basic mathematical treatment of SBS is set forth in the book Quantum Electronics (2^{nd} Ed.) by Amnon Yariv, published by John Wiley & Sons, ISBN 0-471-97176-6, on pages 491-496. SBS results from photons being scattered by localized refractive index variations induced by acoustic waves. The acoustic waves arise due to the time-varying electromagnetic field of the guided light generating a corresponding time-varying electrostrictive strain in the glass lattice that makes up the core of the optical fiber. The SBS threshold power is defined as the point where the amount of backscattered power quickly increases with the amount of input power. The SBS threshold power diminishes as the light source linewidth narrows, thereby rendering problematic the use of a narrow-linewidth light source in a high-power analog optical communication system.

Two main approaches have been used to increase the SBS threshold power. The first approach involves changing the refractive index profile or one or more material properties of the optical fiber. The second approach involves increasing (i.e., broadening) the otherwise narrow linewidth of the light source by modulating or dithering the laser drive current, and/or by modulating the amplitude or phase of the laser output.

While these approaches have met with some success, they also have problems. The first approach is impractical because it requires changing the optical fibers in existing optical networks, and because making a re-designed optical fiber is complicated and expensive when compared to re-designing the light source. On the other hand, the second approach suffers from increased susceptibility to dispersion effects that come into play due to the increased linewidth of the transmitted optical signal. In particular, the second approach leads to significant composite second-order (CSO) distortion that arises when a carrier light beam with different modulation frequencies travels over a dispersive optical fiber.

### SUMMARY OF THE INVENTION

One aspect of the invention includes an optical transmitter for use with an optical fiber having an associated stimulated Brillouin scattering (SBS) threshold power. The transmitter includes a light source adapted to emit a continuous-wave (CW) light beam having one or more frequencies. A phase modulator is optically coupled to the light source and to a plurality n of radio-frequency (RF) signal drivers. The RF signal drivers are adapted to generate a corresponding plurality of sinusoidal RF drive signals having respective modulation amplitudes Aₙ, modulation frequencies fₙ, and modulation phases φₙ. The phase modulator phase modulates the light beam, based on the plurality of sinusoidal RF drive signals, to form a phase-modulated carrier light beam. The modulation phases φₙ are chosen to increase the SBS threshold power relative to a baseline SBS threshold power when the phase-modulated carrier light beam travels over the optical fiber. The modulation frequencies fₙ can also be chosen to suppress CSO distortion.

Another aspect of the invention includes a method of phase modulating a continuous-wave (CW) carrier light beam when sending the light beam through an optical fiber. The method includes passing the light beam through a phase modulator and driving the phase modulator with a plurality of sinusoidal radio-frequency (RF) drive signals having respective modulation amplitudes Aₙ, modulation frequencies fₙ, and modulation phases φₙ, so as to form a phase-modulated carrier light beam. The method also includes choosing the optical phases φₙ to increase (e.g., maximize) the SBS threshold power relative to a baseline SBS threshold power. The method optionally includes choosing modulation frequencies fₙ to suppress CSO distortion.

Additional features and advantages of the invention are set forth in the following detailed description, and in part will be readily apparent to those skilled in the art from that description or recognized by practicing the invention as described herein, including the following detailed description, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a schematic diagram of an embodiment of the analog optical transmitter of the present invention as part of an analog optical communication system;

FIG. 2 is a plot of the carrier light beam optical power (in dBm) vs. wavelength (nm) obtained by experiment (solid line) and by modeling (dashed line) for the case of a single-tone sinusoidal RF phase modulator drive signal applied to the carrier light beam;

FIG. 3 is the same type of plot as FIG. 2, but compares experimental results vs. modeled results for the case of three-tone sinusoidal RF modulation;

FIG. 4 is a contour plot of the SBS threshold power increase ΔP_{SBS} (dB) as plotted against the amplitude A₂ (radians) and the phase φ₂ (radians) of a second sinusoidal RF phase modulator drive signal for two-tone phase modulation;

FIG. 5 is a contour plot of ΔP_{SBS} similar to that of FIG. 4, but wherein the phase modulation amplitude A₁=A₂ is plotted on the y-axis and the phase difference (φ₂−φ₁) is plotted on the x-axis;

FIG. 6 is a plot of Power (dBm) versus frequency ξ (GHz) illustrating the electrical spectrum of a subcarrier multiplexed (SCM) optical analog signal from a typical optical analog transmitter as detected at a receiver after traveling over 50 km of single-mode optical fiber, illustrating the sub-carrier frequencies and CSO floor below the subcarrier frequencies;

FIG. 7 is the same plot as FIG. 6, but with the optical carrier signal modulated with two phase modulation frequencies f₁ and f₂ without regard to the choice of modulation phases φ₁ and φ₂, illustrating the adverse impact of CSO distortion;

FIG. 8 is a plot of CSO distortion (dBc) versus phase modulation frequency f₂ (GHz), where phase modulation frequency f₁=2.5 GHz, and the modulation index m=0.04, illustrating how the CSO distortion varies with modulation frequency;

FIG. 9 is a grey-scale contour plot of the phase differences (φ₂−φ₁) that correspond to the maximum SBS threshold power P_{SBS} as a function of modulation frequencies f₁ and f₂ (GHz);

FIG. 10 is a grey-scale contour plot of SBS threshold power increase ΔP_{SBS} as a function of modulation frequencies f₁ and f₂ using optimized phase differences (φ₂−φ₁) from FIG. 9; and

FIG. 11 is the same plot as FIG. 7, but with optimized frequencies f₁ and f₂ and an optimized phase difference (φ₂−φ₁) selected using FIG. 9, illustrating the suppression of CSO distortion while optimizing SBS threshold power P_{SBS}.

### DETAILED DESCRIPTION OF THE INVENTION

Reference is now made in detail to the present embodiments of the invention, examples of which are illustrated in the accompanying drawings. Whenever possible, the same reference numerals and symbols are used throughout the drawings to refer to the same or like parts.

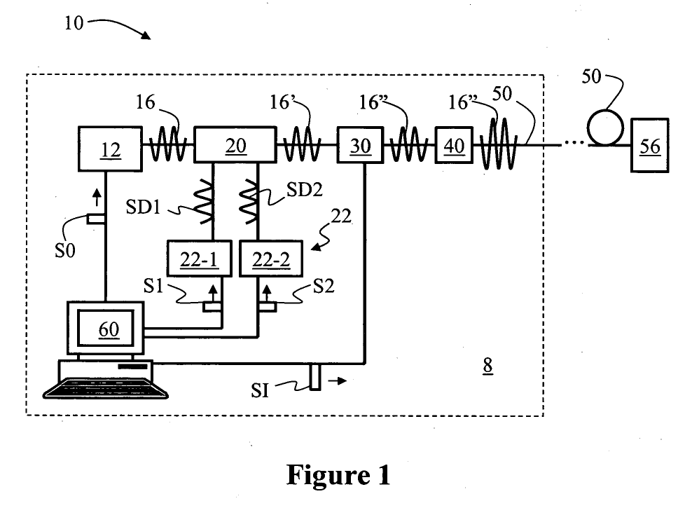

FIG. 1 is schematic diagram of an example embodiment of an analog optical transmitter 8 of the present invention, as part of an analog optical communication system 10. Transmitter 8 includes a light source 12 adapted to output a continuous wave (CW) carrier light beam 16. In an example embodiment, light source 12 is a laser such as a distributed feedback (DFB) laser. In another example embodiment, light source 12 is adapted to generate a multi-frequency CW carrier light beam 16, e.g., by dithering the drive current provided to a DFB laser.

Light source 12 is optically coupled to an optical phase modulator 20, such as an electro-optical phase modulator. In an example embodiment, optical phase modulator 20 is a multi-frequency phase modulator. Optical phase modulator 20 in turn is operably coupled to a plurality of RF signal drivers 22. For the sake of illustration, two RF signal drivers 22-1 and 22-2 are shown and discussed below.

Optical phase modulator 20 is also optically coupled to an optical intensity modulator 30. In an example embodiment, optical intensity modulator 30 is an electro-optical intensity modulator, such as a Mach-Zehnder modulator (MZM). Optical intensity modulator 30 in turn is optically coupled to an optical amplifier 40, such as an erbium-doped fiber amplifier (EDFA). Optical amplifier 40 in turn is optically coupled to an optical fiber link 50 that includes a receiver 56 at its opposite end to complete optical communication system 10.

Transmitter 8 further includes a controller 60 operably coupled to light source 12, to RF drivers 22-1 and 22-1, and to optical intensity modulator 30. In an example embodiment, controller 60 is or includes a computer or like component (e.g., a field-programmable gate array) capable of performing logic operations, including calculations and data processing, and generating control signals for controlling the overall operation of transmitter 8 to carry out the phase modulation operations described in greater detail below.

General Method of Operation

With continuing reference to FIG. 1, in the operation of transmitter 8, controller 60 generates an electrical control signal S0 to activate light source 12. In an example embodiment, control signal S0 is a direct-current (DC) signal that serves as the bias current for a DFB diode laser operating at a wavelength of 1550 nm and a base linewidth of Δυ_{L}=0.01 nm. As discussed above, in an example embodiment, control signal S0 is varied so that carrier light beam 16 includes multiple carrier frequencies.

In response to control signal S0, light source 12 generates CW carrier light beam 16, which travels to phase modulator 20. In the meantime, controller 60 generates control signals S1 and S2 that activate RF signal drivers 22-1 and 22-1, respectively. In response thereto, RF signal drivers 22-1 and 22-2 generate respective sinusoidal RF drive signals SD1 and SD2 having respective amplitudes A₁ and A₂, frequencies f₁ and f₂, and phases φ₁ and φ₂, the choice of which is discussed in greater detail below. RF drive signals SD1 and SD2 drive phase modulator 20 so that carrier light beam 16 passing therethrough is sinusoidally phase modulated with amplitudes A₁ and A₂, frequencies f₁ and f₂, and phases φ₁ and φ₂, thereby generating a phase-modulated carrier light beam 16′.

Phase-modulated carrier light beam 16′ proceeds to intensity modulator 30, which is driven by an RF information signal SI from controller 60. RF information signal SI provides the amplitude-modulated (AM) information imparted to the phase-modulated carrier light beam by intensity modulator 30, thereby forming information-carrying AM light beam 16′. In an example embodiment, RF information signal SI is a subcarrier multiplexed (SCM) signal. AM light beam 16″ then proceeds to EDFA, which amplifies this beam and sends it over optical fiber link 50 to receiver 56.

Multi-Tone Phase Modulation

In an example embodiment of transmitter 8 of the present invention, the phase difference (φ₂−φ₁) between RF drive signals SD1 and SD2 is chosen to increase the SBS threshold power relative to a baseline SBS threshold power P_{BASE} associated with a non-phase-modulated CW carrier light beam propagating in optical fiber link 50. To understand how the modulation phases relate to the SBS threshold power, we start with the equation for the time-varying optical field E(t) for the case of multi-frequency (“multi-tone”) phase modulation of carrier light beam 16, which is given by:

$$E ( t ) = {E}_{0} ( t ) {\prod }_{n = 1}^{N} {ⅇ}^{ⅈ {A}_{n} cos ( 2 π {f}_{n} t + {φ}_{n} )} \qquad Eq . ( 1 )$$

where E₀(t) is the slowly varying amplitude envelope and Aₙ, fₙ, and φₙ are the amplitude, frequency, and phase of the n^{th} frequency (tone), respectively. Since the SBS threshold power depends on the distribution of power in the optical spectrum of the carrier light beam, the optical power spectral density (OPSD) of phase-modulated carrier light beam 16′ is calculated and validated against experiment. This is done, for instance, by calculating the OPSD assuming a CW input and expanding Eq. (1) in a Fourier Bessel series. This approach results in a series of Dirac delta functions with weighting coefficients that depend on Aₙ and φₙ. A Gaussian line shape is applied to each peak, where the linewidth is obtained based on experimental measurements.

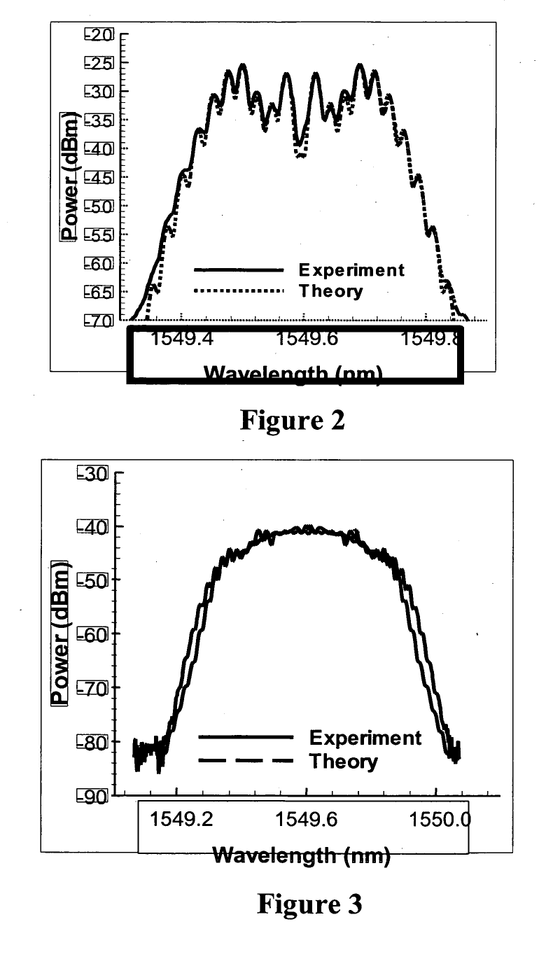

FIG. 2 shows the OPSD of a phase-modulated carrier light beam 16′ as a plot of the optical power (in dBm) vs. wavelength (nm) obtained by experiment (solid line) and by modeling (dashed line) using the above-described approach for the case of a single phase modulation tone at f₁=3.0 GHz and A₁=5.71 rad. The input signal E₀(t) had a measured FWHM linewidth of 1.25 GHz. FIG. 3 is the same plot as FIG. 2, but comparing experimental vs. modeled results for the case of three-tone phase modulation of carrier light beam 16′ with f₁=3.0 GHz, A₁=5.71 rad, f₂=2.75 GHz, A₂=4.92 rad, f₃=2.5 GHz, and A₃=4.72 rad. The relative phases of the three tones are φ₁=3.05 rad, φ₂=3.67 rad, and φ₃=0. The plots of FIG. 2 and FIG. 3 indicate excellent agreement between theory and experiment for both the single-tone and multi-tone cases, indicating that the SBS threshold power can be accurately determined for a carrier light beam having a given number of phase-modulation tones.

Given an optical field with multi-tone phase modulation as expressed by Eq. (1), the SBS threshold power is calculated by integrating the OPSD over the SBS gain bandwidth Δf_{SBS} to obtain the power spectrum as a function of frequency, i.e.,

$$\tilde{P} ( f ) = {\int }_{f}^{f + Δ {f}_{SBS}} {\vert \tilde{E} ( {f}^{′} ) \vert}^{2} ⅆ {f}^{′} . \qquad Eq . ( 2 )$$

The SBS gain bandwidth depends on the optical fiber type and can be as large as 100 MHz in the 1550 nm spectral region. The OPSD of the optical carrier signal having no phase modulation (i.e., the “baseline” power spectrum) is calculated via the relationship:

$${\tilde{P}}_{0} ( f ) = {\int }_{f}^{f + Δ {f}_{SBS}} {\vert {\tilde{E}}_{0} ( {f}^{′} ) \vert}^{2} ⅆ {f}^{′} . \qquad Eq . ( 3 )$$

The baseline SBS threshold power P_{BASE}, as measured in dB, is the SBS threshold power without phase modulation of the carrier light beam and is given by
P_{BASE}=−10 log₁₀[\tilde{P}₀(f)], Eq. (4)
while the SBS threshold power P_{SBS} in dB with phase modulation is given by
P_{SBS}=−10 log₁₀[\tilde{P}(f)]. Eq. (5)

In an example embodiment, the SBS threshold power increase ΔP_{SBS} in dB is defined as:

$$Δ {P}_{SBS} = - 10 {log}_{10} ( \frac{\tilde{P}}{{\tilde{P}}_{0}} ) . \qquad Eq . ( 6 )$$

The maximum SBS threshold power increase is obtained by calculating the maximum value of the SBS threshold power P_{SBS} with phase modulation per Eq. (2) and using that value in Eq. (6).

The impact of phases φ₁ and φ₂ on the SBS threshold power P_{SBS} for the two RF drive signals SD1 and SD2 can be seen by expressing the two-tone optical field as

$$\begin{matrix}E ( t ) = {E}_{0} exp [ ⅈ {A}_{1} cos ( 2 π {f}_{1} t + {φ}_{1} ) ] exp [ ⅈ {A}_{2} cos ( 2 π {f}_{2} t + φ ) ] \\ = {E}_{0} exp [ ⅈ {A}_{1} cos ( {φ}_{1} ) cos ( 2 π {f}_{1} t ) - ⅈ {A}_{1} sin ( {φ}_{1} ) sin ( 2 π {f}_{1} t ) ] . \\ exp [ ⅈ {A}_{2} cos ( {φ}_{2} ) cos ( 2 π {f}_{2} t ) - ⅈ {A}_{2} sin ( {φ}_{2} ) sin ( 2 π {f}_{2} t ) ]\end{matrix} \qquad Eq . ( 7 )$$

Note that the expression for the optical field can be expanded for three or more tones in a similar manner to show the general dependence of the optical field (and thus PSBS) on the multiple modulation phases φₙ. The present invention is described in connection with two-tone modulation and phase difference (φ₂−φ₁) for the sake of illustration. The distribution of the optical spectrum of the carrier light beam depends not only on the strengths of the phase modulation tones f₁ and f₂ but also on the phase difference (φ₂−φ₁), so that the latter choice turns out to have an important effect on the SBS threshold power P_{SBS}.

Increasing PSBS

In an example embodiment of transmitter 8 of the present invention, the SBS threshold power P_{SBS} is increased (e.g., maximized) by appropriately choosing the modulation phases φ₁ and φ₂ for RF drive signals SD1 and SD2. In the discussion below, the relative phase difference (φ₂−φ₁) is also used in connection with choosing the two relative phases.

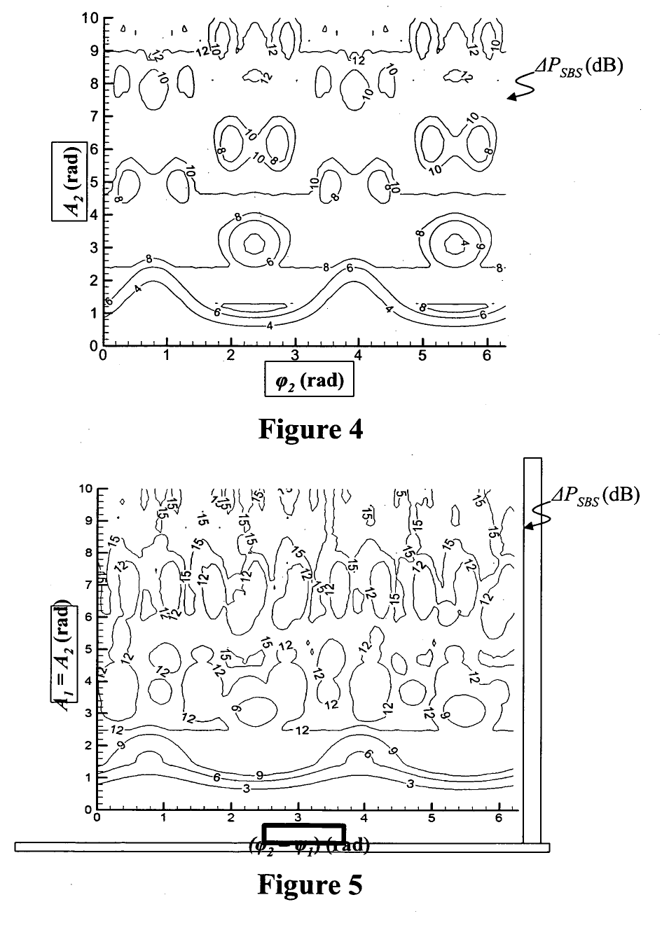

FIG. 4 is a contour plot of the SBS threshold power increase ΔP_{SBS} (dB) as a function of the second tone amplitude A₂ (in radians) and phase φ₂ (in radians) using two-tone phase modulation with sinusoidal driving signals (functions) SD1 and SD2. First driving signal SD1 has a frequency f₁=2.5 GHz, a fixed amplitude A₁=1 rad and a fixed modulation phase φ₁=0. Second driving signal SD2 has a frequency f₂=3 GHz, and a variable amplitude A₂ and a variable phase φ₂ as shown in the plot as the Y-axis and X-axis, respectively. As is evident from the plot, even for relatively non-commensurate frequencies f₁ and f₂, the phase difference (φ₂−φ₁) between the two drive signals SD1 and SD2 affects the SBS threshold power increase ΔP_{SBS} by several dB. One can conservatively set amplitude A₂ to be ˜2.4 radians (corresponding to the root of the zeroth-order J₀ Bessel function) because around this value ΔP_{SBS} is relatively insensitive to phase. However, as FIG. 4 indicates, for a more judicious choice of the phase difference (φ₂−φ₁), even a modest increase in the value of A₂ can lead to substantial increases in the SBS threshold power P_{SBS}.

FIG. 5 is a contour plot of the SBS threshold power increase ΔP_{SBS} similar to that of FIG. 4, but wherein the phase modulation amplitude A₁=A₂ is plotted on the y-axis and the phase difference (φ₂−φ₁) is plotted on the x-axis. Again, f₁=2.5 GHz and f₂=3.0 GHz. The plot of FIG. 5 illustrates the significance of properly choosing the phase φₙ of the RF drive signals. By way of example, according to FIG. 5, if equal drive amplitudes are employed for drive signals SD1 and SD2 and the phase difference (φ₂−φ₁) is chosen to be 2.0 radians, then the SBS threshold power P_{SBS} can be increased by 17 dB using A₁=A₂=4.8 radians.

Increasing P_{SBS} while Suppressing CSO Distortion

In some instances, increasing the SBS threshold power P_{SBS} via phase modulation of carrier light beam 16 can incur huge penalties in the form of CSO distortion due to the interaction of the different phase modulation frequencies in carrier light beam 16′ with chromatic dispersion in optical fiber 50. While chromatic dispersion is not problematic at or near the minimum dispersion wavelength of 1310 nm, it becomes particularly pronounced at 1550 nm. This is because chromatic dispersion is relatively strong (e.g., ˜17 ps/nm-km for standard telecommunications optical fiber) at 1550 nm, and because CSO distortions increase with the fourth power of dispersion (and thus with the fourth power of the optical fiber length). A discussion of the dependence of CSO distortions on fiber dispersion (length), is provided by M. R. Phillips and T. E. Darcie in their article “Lightwave Analog Video Transmission,” published in Optical Fiber Telecommunications vol. IIIA, (ed. I. P. Kaminow and T. L. Koch, Academic Press (San Diego, 1997)), p. 548. CSO distortions can therefore significantly degrade the optical transmission even after propagating through only 50 km of optical fiber.

Accordingly, in another example embodiment of transmitter 8 of the present invention, the SBS threshold power P_{SBS} is increased from the baseline value P_{BASE} to a desired level (e.g., is maximized) while the CSO distortions are suppressed by controlling interaction between phase modulation tones (frequencies) and the optical fiber dispersion. In an example embodiment of the present invention, this is accomplished by appropriately choosing both the phase modulation frequencies fₙ and modulation phase difference φₙ.

Subcarrier Multiplexing

Subcarrier multiplexing (SCM) involves imposing information at multiple frequencies (typically spaced a few MHz apart) onto a single carrier. These subcarriers are weakly modulated so as not to generate an excessive amount of harmonics. Analog TV channels in the U.S. have to follow a grid panel specified by the Federal Communications Commission (FCC). These subcarriers start at 55.25 MHz and are spaced nominally 6 MHz apart, but to reduce composite second-order (CSO) beats, the grid spacing is not completely even. The standard channel plan extends up to 550 MHz and the extended channel plan extends up to 1 GHz.

Generating SCM signals is accomplished in transmitter 8 by intensity modulating phase-modulated carrier light beam 16′ with the subcarrier information provided to intensity modulator 30 using RF information signal SI from controller 60. Since the subcarrier modulation is weak, with direct modulation one can achieve a nearly linear transfer function and write the output optical field of (SCM) light beam 16″ as:

$$E ( t ) = {E}_{0} [ 1 + m {\sum }_{k = 1}^{N} cos ( 2 π {v}_{k} t + {ξ}_{k} ) ] {ⅇ}^{{ⅈ2πη}_{0} t} , \qquad Eq . ( 8 )$$

where E₀ refers to the amplitude of the optical field, η₀ is the optical carrier frequency (assuming a single-frequency carrier), ξ is the modulation frequency, and m is the modulation index.

Receiver 56 in optical communication system 10 operates by converting the optical field to an electrical current. This operation involves converting the optical field into an optical intensity, which is equivalent to squaring the incoming optical field. When the optical field is modulated using subcarrier multiplexing, as in Equation (8), the squaring leads to higher-order terms proportional to m² that collectively represent CSO distortion. However, as mentioned above, CSO distortion also arises due to the multi-frequency phase modulations already imparted to carrier light beam 16′. Such CSO distortion can represent a CSO distortion “penalty” when it adds to the CSO distortion already inherent with information-carrying SCM light beam 16″.

In an example embodiment of the present invention, the CSO “penalty” is numerically modeled by defining the optical field on a fine array, while the receiver is modeled by numerically squaring the optical field, thereby generating CSO distortion tones.

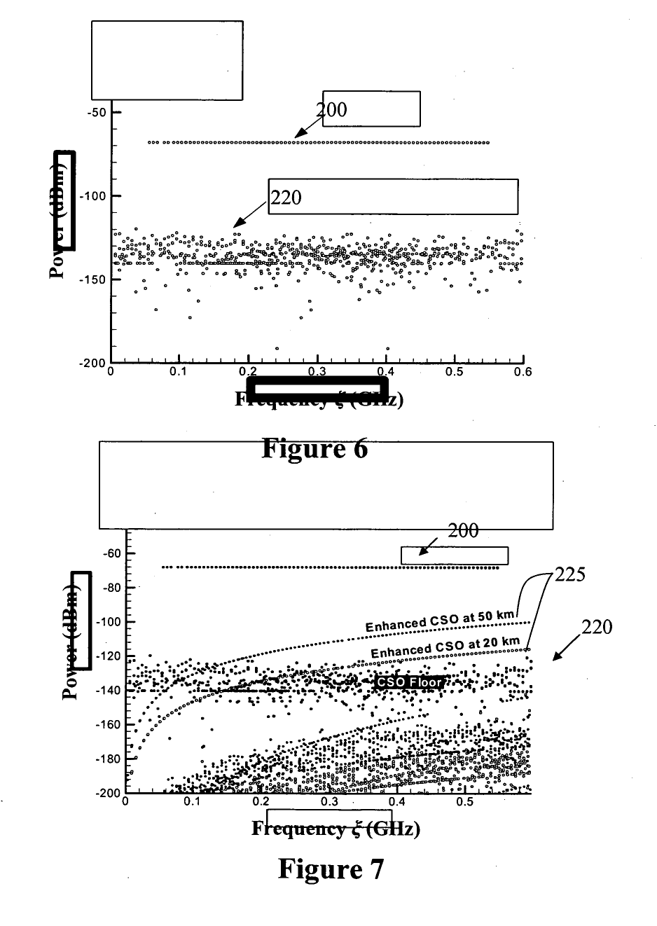

FIG. 6 is a plot of Power (dBm) versus frequency ξ (GHz) illustrating the electrical spectrum of an (SCM) optical analog signal from a typical optical analog transmitter as detected at a receiver after traveling over 50 km of single-mode optical fiber, wherein the underlying optical carrier (16′) is not phase modulated. The signal information is stored at subcarrier frequencies (subcarriers) 200. Upon detection, the receiver effectively squares the optical field, thereby creating a floor 220 of CSO beat tones that lie below the subcarriers 200.

FIG. 7 is the same plot as FIG. 6, but with the underlying optical carrier 16′ modulated with two frequencies f₁ and f₂ without regard to the choice of phases φ₁ and φ₂. The plot shows that the interaction between the phase modulation and the fiber dispersion leads to an increase in CSO distortion, which rises above CSO floor 220. The net effect of the increase in CSO distortion is a degradation in signal quality.

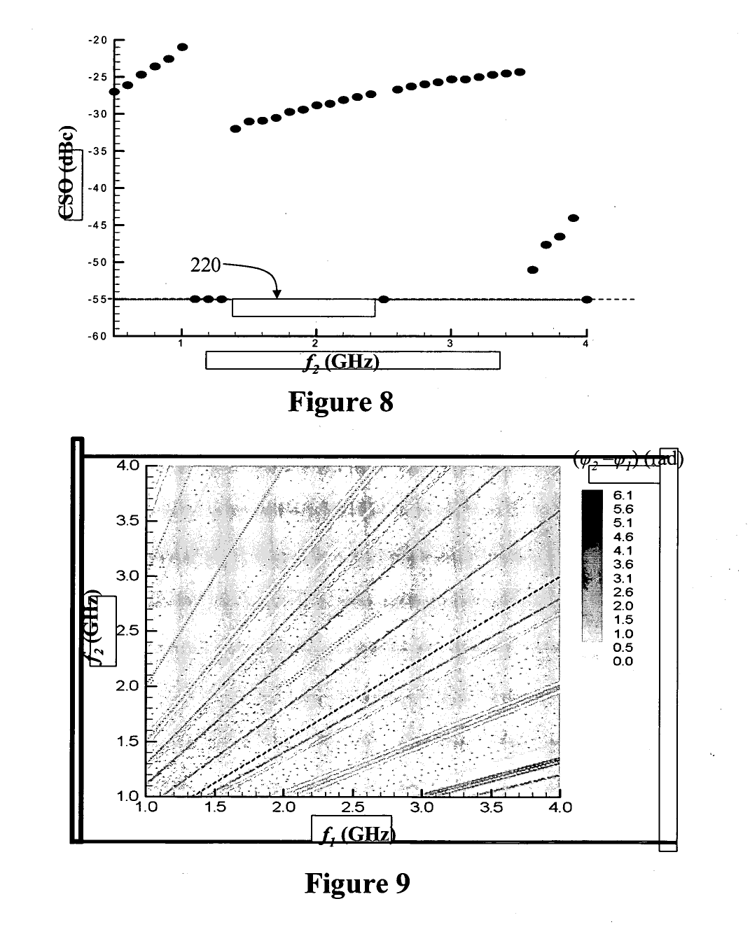

FIG. 8 is a plot of CSO distortion (dBc) versus phase modulation frequency f₂ calculated based on numerical modeling of the optical field as described above. The phase modulation frequency f₁ was held constant at 2.5 GHz and the modulation index m was set at 0.04. As is evident from the plot, CSO distortion is suppressed when f₂ is about 1.25 GHz as well as at about 3.75 GHz, which corresponds to f₂=(0.5)f₁ and f₂=(1.5)f₁, respectively. This information allows one to choose modulation frequencies f₁ and f₂ that suppress CSO distortion.

FIG. 9 is a contour plot of the phase differences (φ₂−φ₁) that correspond to the maximum SBS threshold power P_{SBS} as a function of modulation frequencies f₁ and f₂. The plot illustrates how to select the phase difference (φ₂−φ₁) for a given combination of modulation frequencies to maximize P_{SBS}. Combined with the information from FIG. 8, one is able to choose both a phase difference (φ₂−φ₁) that maximizes SBS threshold power P_{SBS} while also choosing frequencies f₁ and f₂ that suppress CSO distortion.

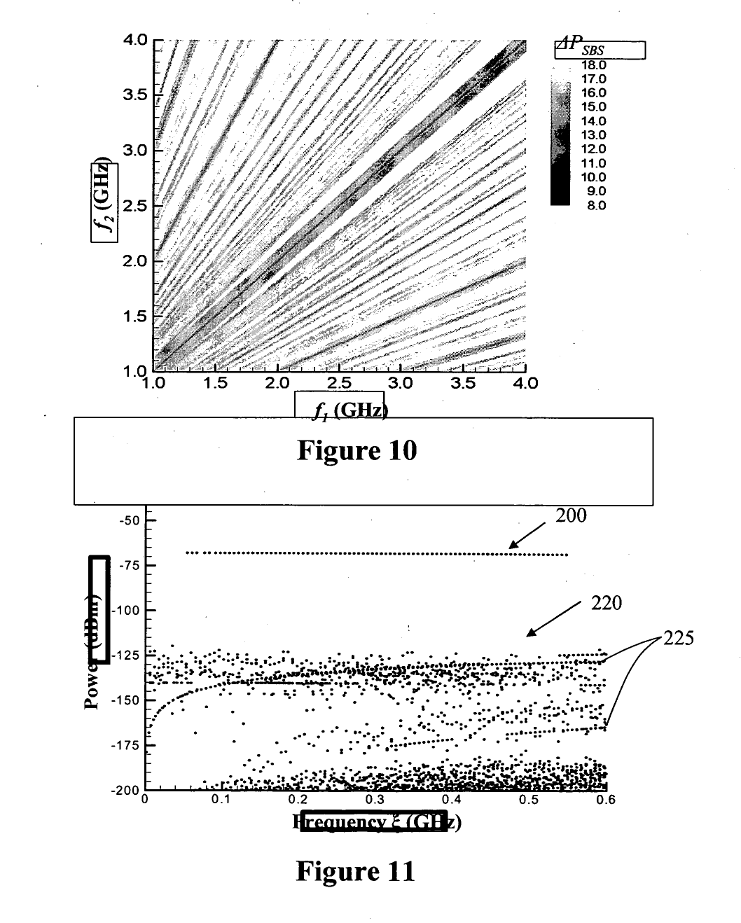

FIG. 10 is a contour plot of the SBS threshold power increase ΔP_{SBS} as a function of modulation frequencies f₁ and f₂ when the optimized phase differences (φ₂−φ₁) of FIG. 9 are used. The drive signal amplitudes were set at A₁=A₂=2 radians. The plot shows that the SBS threshold power increase ΔP_{SBS} can actually be maximized for the case 2 f₁=3 f₂, which might otherwise be a poor choice of frequencies when the phase difference is not properly considered. Accordingly, when f₁=3.6 GHz and f₂=2.4 GHz, an SBS threshold power increase of over 10 dB is obtained. Greater values for amplitudes A₁ and A₂ generally lead to a correspondingly greater SBS threshold power increase. However, in practice A₁ and A₂ cannot be arbitrarily increased due to the physical limitations of intensity modulator 30, such as the limit in the drive power that can be provided to a conventional electro-optic intensity modulator. In an example embodiment, amplitudes Aₙ do not exceed 8 radians, and are preferably in the following range: 2 radians<Aₙ<8 radians. In a more specific example embodiment, amplitudes Aₙ˜6.2 radians.

FIG. 11 is a plot similar to that of FIG. 7, but wherein optimized frequencies f₁ and f₂ and an optimized phase difference (φ₂−φ₁) were chosen based on the approach described above. In particular, f₁=3.5 GHz and f₂=2.33 GHz, A₁=A₂=2 radians, and (φ₂−φ₁)=1.6 radians. These values provide an SBS threshold power increase ΔP_{SBS} of over 10 dB, as deduced from the plot of FIG. 10. The plot of FIG. 11 shows that CSO tones 225 generated by the interaction between the phase-modulation and the dispersion are buried in CSO floor 200, indicating that the CSO penalty after propagating through 50 km of optical fiber is negligible. This is in sharp contrast to the plot of FIG. 7, where failure to choose the proper combination of phase difference (φ₂−φ₁) and frequencies f₁ and f₂ resulted in a CSO penalty of about 20 dB.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An optical transmitter for use with an optical fiber having an associated stimulated Brillouin scattering (SBS) threshold power, comprising:
a light source adapted to emit a continuous-wave (CW) light beam having one or more frequencies;
a phase modulator optically coupled to the light source and operably coupled to a plurality n of radio-frequency (RF) signal drivers adapted to generate a corresponding plurality of sinusoidal RF drive signals having respective modulation amplitudes Aₙ, modulation frequencies fₙ, and modulation phases φₙ, wherein the phase modulator phase modulates the light beam based on the plurality of sinusoidal RF drive signals to form a phase-modulated carrier light beam; and
wherein the modulation phases φₙ are chosen to increase the SBS threshold power relative to a baseline SBS threshold power when the phase-modulated carrier light beam travels over the optical fiber.

2. The optical transmitter of claim 1, wherein the phase modulator is a multi-frequency phase modulator, and wherein the modulation frequencies fₙ are chosen so as to suppress combined second order (CSO) distortion when the information-carrying signal travels over the optical fiber.

3. The optical transmitter of claim 1, wherein the modulation phases φₙ are chosen to maximize the SBS threshold power when the information-carrying signal travels over the optical fiber.

4. The optical transmitter of claim 1, wherein the CW light beam has a single carrier frequency.

5. The optical transmitter of claim 1, including:
an intensity modulator optically coupled to the phase modulator and driven by an information signal so as to form a subcarrier modulated (SCM) information-carrying optical signal.

6. An analog optical communication system, comprising:
the optical transmitter of claim 1 optically coupled to one end of the optical fiber; and
an optical receiver optically coupled to the optical fiber at an end opposite the transmitter and adapted to receive the information-carrying optical signal.

7. An optical transmitter for use with an optical fiber having an associated stimulated Brillouin scattering (SBS) threshold power, comprising:
a light source adapted to emit a continuous-wave (CW) light beam;
a phase modulator optically coupled to the light source and operably coupled to first and second radio-frequency (RF) signal drivers adapted to generate respective first and second sinusoidal RF drive signals having respective first and second modulation amplitudes A₁ and A₂, first and second modulation frequencies f₁ and f₂, and first and second modulation phases φ₁ and φ₂ that define an optical phase difference, wherein the phase modulator phase modulates the light beam based on the first and second sinusoidal RF drive signals to form a phase-modulated carrier light beam;
an intensity modulator optically coupled to the phase modulator and adapted to impart an RF modulation to the phase-modulated carrier light beam based on an information-carrying RF signal; and
wherein the optical phase difference is chosen to increase the SBS threshold power relative to a baseline SBS threshold power when the information-carrying optical signal travels over the optical fiber.

8. The optical transmitter of claim 7, wherein the first and second RF signal drivers are adapted to provide corresponding first and second drive frequencies f₁ and f₂ that suppress combined second order (CSO) distortion when the phase-modulated carrier light beam travels over the optical fiber.

9. The optical transmitter of claim 7, wherein a modulation phase difference (φ₂−φ₁) is chosen to maximize the SBS threshold power when the phase-modulated carrier light beam travels over the optical fiber.

10. The optical transmitter of claim 7, including:.
an intensity modulator optically coupled to the phase modulator and driven by an information signal so as to form a subcarrier modulated (SCM) information-carrying optical signal.

11. The optical transmitter of claim 7, wherein the CW light beam has a single carrier frequency.

12. An analog optical communication system, comprising:
the optical transmitter of claim 7 optically coupled to one end of the optical fiber;
an optical receiver optically coupled to the optical fiber at an end opposite the transmitter and adapted to detect the SCM information-carrying optical signal.

13. A method of phase-modulating a continuous-wave (CW) carrier light beam when sending the light beam through an optical fiber having an associated stimulated Brillouin scattering (SBS) threshold power, the method comprising:
passing the light beam through a phase modulator;
driving the phase modulator with a plurality of sinusoidal radio-frequency (RF) drive signals having respective modulation amplitudes Aₙ, respective modulation frequencies fₙ, and respective modulation phases φₙ, so as to form a phase-modulated carrier light beam; and
choosing the optical phases φₙ to increase the SBS threshold power relative to a baseline SBS threshold power.

14. The method of claim 13, wherein the optical fiber has chromatic dispersion at a wavelength of the carrier light beam, and including:
choosing the modulation frequencies fₙ so as to suppress combined second-order (CSO) distortion when the phase-modulated carrier light beam travels through the optical fiber.

15. The method of claim 13, including choosing amplitudes Aₙ to be in the range defined by: 2 radians<Aₙ<8 radians.

16. The method of claim 13, including intensity-modulating the phase-modulated carrier light beam to form an information-carrying optical signal.

17. The method of claim 16, including detecting the information-carrying optical signal at a receiver.

18. The method of claim 16, wherein forming the information-carrying signal includes subcarrier modulating the phase-modulated carrier light beam.

19. The method of claim 13, including forming the CW carrier light beam to have a single carrier frequency.

20. The method of claim 13, including choosing the optical phases φₙ to maximize the SBS threshold power.
